(19) United States
(12) Patent Application Publication
(10) Pub. No.: US 2026/0122666 A1
(43) Pub. Date: Apr. 30, 2026

(54) SCHEDULING OF PRIORITIZED SIGNALS WHEN USING RADIO POWER OVERBOOKING

(71) Applicant: Telefonaktiebolaget LM Ericsson (publ), Stockholm (SE)

(72) Inventors: Erik LARSSON, UPPSALA (SE); Shiguang GUO, KANATA (CA)

(73) Assignee: Telefonaktiebolaget LM Ericsson (publ), Stockholm (SE)

(21) Appl. No.: 19/117,164

(22) PCT Filed: Sep. 30, 2022
(86) PCT No.: PCT/SE2022/050878

§ 371 Date: Mar. 31, 2025

(51) Int. Cl. H04W 72/563; H04W 52/34

(52) U.S. Cl. CPC H04W 72/563; H04W 52/346

(57) ABSTRACT

There is provided techniques for scheduling prioritized signals for transmission on carriers using a radio unit with radio power overbooking. The radio unit has a maximum power capability P^{max} and the radio unit and the carriers are configured with a total power P>P^{max}. A method is performed by a network node. The method comprises identifying a maximum power backoff P^{o} due to the radio power overbooking as P^{o}=P−P^{max}. The method comprises blocking

$${β}_{k}^{r e s}$$

resources not carrying the prioritized signals from being scheduled for carrier k in a symbol where the prioritized signals are scheduled, where the prioritized signals are scheduled in

$${β}_{k}^{P r i o}$$

resources for carrier k, and where

$${β}_{k}^{r e s}$$

is a function of

$${β}_{k}^{P r i o}$$

and P^{o}.

### TECHNICAL FIELD

Embodiments presented herein relate to a method, a network node, a computer program, and a computer program product for scheduling prioritized signals for transmission on carriers using a radio unit with radio power overbooking.

### BACKGROUND

Mobile networks are becoming increasingly more complex with several mobile network operators employing different radio access technologies on a diverse set of frequency bands. Further, the size, weight, and cost of the radio unit should be kept as small as possible without compromising on key performance indicators (KPIs). One approach is therefore to develop radio units capable of multiband operation, or even wideband operation, where one radio unit and antenna system can handle operation at several frequency bands. Further, the output power of the radio unit is a key dimensioning factor in terms of size and weight of the radio unit; more output power requires more cooling which leads to larger size and weight. By employing power pooling, that is, efficiently using the total power in a pooled manner over several carriers (and/or sectors) in a radio unit during multiband operation, the total output power can be reduced without impacting important KPIs, such as network coverage.

One way to achieve power pooling benefits is radio power overbooking. In general terms, radio power overbooking means that the carriers are configured with in total more power than what the radio unit is capable of transmitting. As an introductory illustrative example, consider a radio unit capable of multiband operation and with a maximum total output power of max 60 W. Assume that the radio unit is configured with two carriers, where each carrier can have a maximum output power of 40 W and a bandwidth of 20 MHz. This means that the carriers are typically configured with a power spectral density (PSD) of 2 W/MHz. Evidently, 40+40>60[W], and hence if both carriers are scheduled to use more than 30 MHz (30 MHz times 2 W/MHz=60 W), then the PSD needs to be scaled down. However, if the total utilization of both carriers is low enough (i.e., less than 30 MHz), then the PSD target of 2 W/MHz can be kept.

Radio power overbooking is typically transparent to processing in the digital baseband unit, meaning that baseband operations, such as scheduling, will assume always having access to the configured power of the radio unit (i.e., 40 W per each 20 MHz carrier, or 2 W/MHz, in the example above). It is then up to the radio unit to ensure that the total radio capability (60 W in the example above) is never exceeded. The radio unit achieves this by scaling down the power of its carriers whenever the maximum capability of the radio unit is exceeded.

There could be challenges when radio power overbooking is used. Radio resource management (RRM) will be used as an examples to this. RRM is one example where prioritized signals, in terms of reference signals, are transmitted.

In general terms, RRM functionalities comprise traffic management and mobility. Traffic management concerns aspects such as how to distribute users (as represented by user equipment served by the network) and traffic over different carriers to best utilize the available resources, taking quality of service (QoS) into consideration (also referred to as load balancing). Mobility control aims at ensuring a seamless transfer of users between different cells (geographical areas) for user equipment in connected mode and handles cell selection/re-selection of users for user equipment in idle mode, and thereby ensures that user equipment connect and camp on the correct cell.

In general terms, RRM functionalities rely on long-term channel state information (CSI) to make good decisions. Such CSI might be acquired via measurement reports sent by the user equipment. One example of a reported parameter is SS-RSRP, short for synchronization signal reference signal received power. SS-RSRP reflects the signal quality of the synchronization signal block (SSB), which is a cell-defining signal transmitted in the downlink. Thus, reported parameter gives an estimate of the cell-wide signal quality for a particular cell. This reported parameter can, for example, be used for cell selection/re-selection and for traffic management.

All parameters of measurement reports sent by the user equipment are conditioned on the output power, or power spectral density (PSD), of the radio unit from which the downlink reference signals are transmitted over the air. With power overbooking, the radio unit blindly reduces the power of all transmitted signals on all carriers whenever the maximum power capability of the radio unit is exceeded. In fact, many radio units operate on time-domain signals without any knowledge about their information content. Thus, the radio unit cannot differentiate between different signals, or physical channels. Furthermore, the baseband unit is unaware of how and if the radio unit has scaled the PSD of a particular signal. This means that RRM functionalities that are conditioned and derived based on a fixed PSD will not reflect the true conditions of the radio environment. It would rather appear as if the radio environment is worse than what it truly is. Furthermore, as the baseband unit is unaware of how and if the radio unit has scaled the power, the baseband unit cannot compensate reported parameters from the user equipment that are based on the actual, potentially power scaled, PSD of relevant signals. This unawareness and the fact that power-scaling occurs now and then might thus create fluctuations in signal levels used by the RRM functionalities.

More generally, the network operation contains several control loops that counteract various system uncertainties and ensure a robust and predictable network behaviour. However, different control loops operating at different time-constants can be sensitive to unaware signal fluctuations caused by, for example, power overbooking as discussed above. This kind of signal fluctuation can even lead to system instability.

Hence, there is still a need for an improved handling of prioritized signals where radio power overbooking is used.

### SUMMARY

An object of embodiments herein is to address the above issues by providing techniques for scheduling prioritized signals for transmission on carriers by a radio unit that uses radio power overbooking.

According to a first aspect there is presented a method for scheduling prioritized signals for transmission on carriers using a radio unit with radio power overbooking. The radio unit has a maximum power capability P^{max} and the radio unit and the carriers are configured with a total power P>P^{max}. The method is performed by a network node. The method comprises identifying a maximum power backoff P^{o} due to the radio power overbooking as P^{o}=P−P^{max}. The method comprises blocking

$${β}_{k}^{r e s}$$

resources not carrying the prioritized signals from being scheduled for carrier k in a symbol where the prioritized signals are scheduled, where the prioritized signals are scheduled in

$${β}_{k}^{Prio}$$

resources for carrier k, and where

$${β}_{k}^{res}$$

is a function of

$${β}_{k}^{P r i o}$$

### and P^{o}.

According to a second aspect there is presented a network node for scheduling prioritized signals for transmission on carriers using a radio unit with radio power overbooking. The radio unit has a maximum power capability P^{max} and the radio unit and the carriers are configured with a total power P>P^{max}. The network node comprises processing circuitry. The processing circuitry is configured to cause the network node to identify a maximum power backoff P^{o} due to the radio power overbooking as P^{o}=P−P^{max}. The processing circuitry is configured to cause the network node to block

$${β}_{k}^{r e s}$$

resources not carrying the prioritized signals from being scheduled for carrier k in a symbol where the prioritized signals are scheduled, where the prioritized signals are scheduled in

$${β}_{k}^{P r i o}$$

resources for carrier k, and where

$${β}_{k}^{r e s}$$

is a function of

$${β}_{k}^{P r i o}$$

### and P^{o}.

According to a third aspect there is presented a network node for scheduling prioritized signals for transmission on carriers using a radio unit with radio power overbooking. The radio unit has a maximum power capability P^{max} and the radio unit and the carriers are configured with a total power P>P^{max}. The network node comprises an identify module configured to identify a maximum power backoff P^{o} due to the radio power overbooking as P^{o}=P−P^{max}. The network node comprises a block module configured to block

$${β}_{k}^{r e s}$$

resources not carrying the prioritized signals from being scheduled for carrier k in a symbol where the prioritized signals are scheduled, where the prioritized signals are scheduled in

$${β}_{k}^{P r i o}$$

resources for carrier k, and where

$${β}_{k}^{res}$$

is a function of

$${β}_{k}^{Prio}$$

### and P^{o}.

According to a fourth aspect there is presented a computer program for scheduling prioritized signals for transmission on carriers using a radio unit with radio power overbooking, the computer program comprising computer program code which, when run on a network node, causes the network node to perform a method according to the first aspect.

According to a fifth aspect there is presented a computer program product comprising a computer program according to the fourth aspect and a computer readable storage medium on which the computer program is stored. The computer readable storage medium could be a non-transitory computer readable storage medium.

Advantageously, these aspects provide efficient handling of prioritized signals where radio power overbooking is used without suffering from the above identified issues.

Advantageously, these aspects ensure that radio power overbooking does not affect scenarios where prioritized signals are transmitted.

Advantageously, these aspects therefore facilitate more robust RRM functionalities, e.g., in terms of traffic and mobility handling, and ensure that cell coverage defined by cell-defining reference signals is unaffected.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communications network according to embodiments;

FIG. 2 schematically illustrates a time-frequency resource grid according to embodiments;

FIG. 3 is a block diagram of a network node according to embodiments;

FIG. 4 is a flowchart of methods according to embodiments;

FIG. 5 schematically illustrates blocking of resources when prioritized signals are scheduled according to embodiments;

FIG. 6 schematically illustrates an SSB according to embodiments;

FIG. 7 is a schematic diagram showing functional units of a network node according to an embodiment;

FIG. 8 is a schematic diagram showing functional modules of a network node according to an embodiment; and

FIG. 9 shows one example of a computer program product comprising computer readable storage medium according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

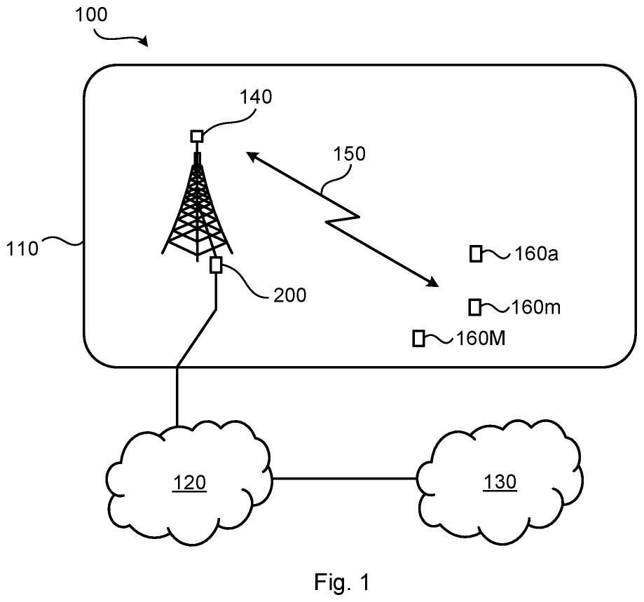

FIG. 1 is a schematic diagram illustrating a communication network 100 where embodiments presented herein can be applied. The communication network 100 could be a third generation (3G) telecommunications network, a fourth generation (4G) telecommunications network, a fifth generation (5G) telecommunications network, a sixth generation (6G) telecommunications, or any evolvement or combination thereof, and support any third generation partnership project (3GPP) telecommunications standard, where applicable. The communication network 100 comprises a network node 200 configured to provide network access to user equipment 160a, 160m, 160M, over wireless links 150 in a (radio) access network 110. The (radio) access network 110 is operatively connected to a core network 120. The core network 120 is in turn operatively connected to a service network 130, such as the Internet. The user equipment 160a:160M are thereby enabled to, via the network node 200, access services of, and exchange data with, the service network 130. The network node 200 comprises a digital baseband unit and is operatively connected to a radio unit 140. Examples of network nodes 200 are radio access network nodes, radio base stations, base transceiver stations, Node Bs, evolved Node Bs, gNBs, access points, and backhaul nodes. Examples of user equipment 160a:160M are terminal devices, wireless devices, mobile stations, mobile phones, handsets, wireless local loop phones, smartphones, laptop computers, tablet computers, network equipped sensors, network equipped vehicles, customer-premises equipment, and so-called Internet of Things devices.

It is assumed that the radio unit is capable of performing radio power overbooking. As noted above there is still a need for an improved handling of prioritized signals where radio power overbooking is used.

One aim of the present inventive concept is to make transmission of prioritized signals more robust to radio power overbooking. This can be achieved by making the prioritized signals resilient towards the radio power overbooking. In essence, the radio power overbooking can be avoided in symbols carrying prioritized signals. In case the prioritized signals are downlink (cell-defining) reference signals, this makes RRM based on reported signal quality of the reference signals more robust in situations where radio power overbooking is used.

The embodiments disclosed herein in particular relate to techniques for scheduling prioritized signals for transmission on carriers using a radio unit with radio power overbooking. In order to obtain such techniques there is provided a network node 200, a method performed by the network node 200, a computer program product comprising code, for example in the form of a computer program, that when run on a network node 200, causes the network node 200 to perform the method.

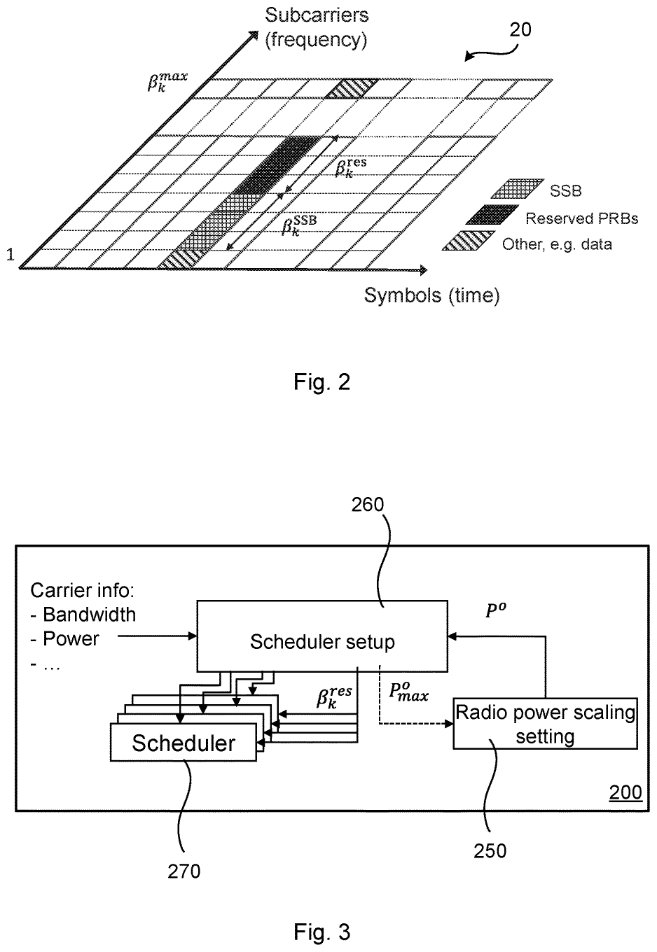

Consider a specific time symbol in the time-frequency resource grid 20 illustrated in FIG. 2. Let αₖ and

$${β}_{k}^{max}$$

denote the PSD and the total number of resources for carrier k, respectively. Furthermore, let

$${β}_{k}^{SSB} and {β}_{k}^{res}$$

represent the number of resources for a prioritized signal, such as an SSB, and the number of restricted (i.e., blocked) resources due to radio power overbooking for carrier k, respectively. These quantities could use different units. Hereinafter, the PSD will be represented as W/MHz and resources in MHz. However, another example is that PSD is represented as total power divided by total number of physical resource blocks (PRBs) and that utilization is given as the number of used PRBs. The power of a specific signal in a specific symbol and carrier is given by the PSD times the resource utilization. For example, the power corresponding to the blocked resources in a specific symbol and carrier k is

$${α}_{k} {β}_{k}^{res} .$$

Let K denote the total number of carriers that are potentially subject to radio power overbooking. Further, assume that the associated carriers are configured with a total power of P, whilst the maximum power capability of the radio unit is P^{max} (where p>P^{max}). Hence, P^{o}=P−P^{max} is the maximum reduction in power (i.e., power backoff) due to radio power overbooking. The power allocated to carrier k is denoted Pₖ, where:

$${\sum }_{k} {P}_{k} = P .$$

One typical configuration is:

$${α}_{k} = \frac{{P}_{k}}{{β}_{k}^{max}} .$$

Consider a specific time symbol. If the sum of the PSD times the blocked resources over all carriers handled by the radio unit is larger than, or equal to, the maximum backoff in power due to radio power overbooking, then no power scaling needs to be applied in the radio unit. Hence the configured and experienced PSD will then be the same. Therefore, given the definitions above, the network node can, for scheduling carrier k, adopt a rule specifying that in symbols where a prioritized signal (using

$${β}_{k}^{SSB}$$

resources) is to be transmitted, then

$${β}_{k}^{res}$$

resources are restricted, or blocked, from being scheduled.

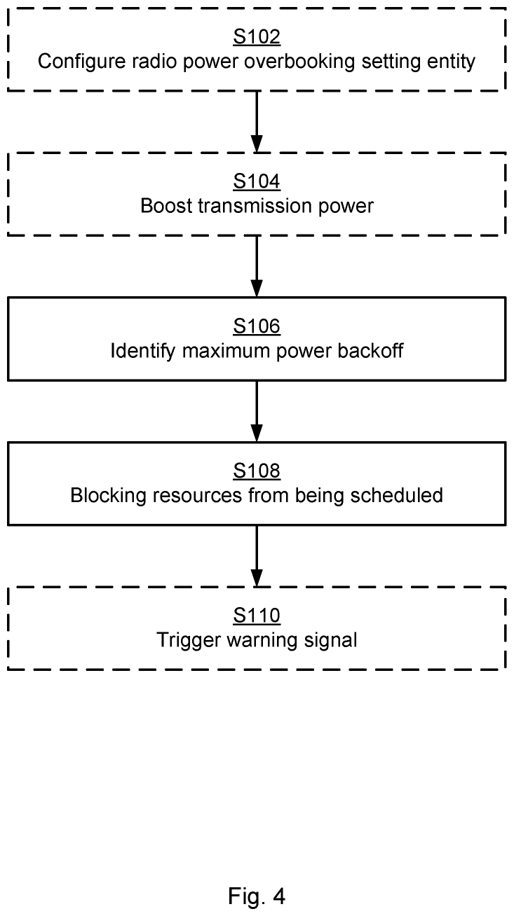

FIG. 3 is a block diagram of a network node 200 according to an embodiment. The radio power scaling is managed by a radio power scaling setting entity 250. A scheduler setup entity 260 calculates the resource restriction for symbols in which prioritized signals are scheduled based on various information and feeds the restriction parameter to the associated schedulers 270. Each carrier k may have its own independent scheduler. Operation of the network node 200 will be disclosed next with reference to FIG. 4.

FIG. 4 is a flowchart illustrating embodiments of methods for scheduling prioritized signals for transmission on carriers using a radio unit with radio power overbooking. The radio unit has a maximum power capability P^{max}. The radio unit and the carriers are configured with a total power P>P^{max}. The methods are performed by the network node 200. The methods are advantageously provided as computer programs 920.

At least some of the herein disclosed embodiments aim at ensuring that radio power overbooking is not used whenever a prioritized signal is scheduled. According to at least some of the herein disclosed embodiments this is accomplished by prohibiting scheduling of some resources, such as PRBs, (that do not carry prioritized signals) in symbols in which prioritized signals are scheduling other resources.

S106: The network node 200 identifies a maximum power backoff P^{o} due to the radio power overbooking as P^{o}=P−P^{max}.

S108: The network node 200 blocks

$${β}_{k}^{r e s}$$

resources not carrying the prioritized signals from being scheduled for carrier k in a symbol where the prioritized signals are scheduled, where the prioritized signals are scheduled in

$${β}_{k}^{Prio}$$

resources for carrier k, and where

$${β}_{k}^{res}$$

is a function of

$${β}_{k}^{Prio}$$

### and P^{o}.

Thus, scheduling of some PRBs not carrying prioritized signals in symbols scheduling prioritized signals can be prohibited by using P^{max} and P to calculate P^{o}, then calculating

$${β}_{k}^{res}$$

from P^{o} and

$${β}_{k}^{Prio} .$$

The scheduler for carrier k can then be informed about

$${β}_{k}^{res} .$$

As noted above, there could be different units in which some of the quantities, for example

$${β}_{k}^{S S B} and {β}_{k}^{r e s} ,$$

are expressed. In some embodiments, the resources to be blocked are defined in terms of at least one frequency interval or number of physical resource blocks, PRBs. However, also other units could be used.

Embodiments relating to further details of scheduling prioritized signals for transmission on carriers using a radio unit with radio power overbooking as performed by the network node 200 will now be disclosed.

In some aspects, each carrier k=1 . . . K has an associated independent scheduler. That is, in some embodiments, there are K carriers in total, where each of the carriers has its own scheduler, and where the scheduler for carrier k is operable independently of any other of the schedulers. In other aspects, at least two of the carriers share one and the same scheduler.

In further aspects, that

$${β}_{k}^{res}$$

resources are to be blocked might be determined by a baseband entity or a scheduler setup entity in the network node, where information that the

$${β}_{k}^{res}$$

resources are to be blocked is provided to a scheduler in the network node for carrier k. Different approaches to inform the schedulers about when to apply the additional blocking rule can be envisioned. For example, the setup function could give each scheduler a periodic pattern indicating when in time to apply the rule, for example, which slot numbers and/or symbol numbers (modulus the periodicity time). In some examples, the information that

$${β}_{k}^{res}$$

resources are to be blocked is provided as an index to a table accessible to the scheduler for carrier k.

It is envisioned that the network node might either have very limited knowledge about scheduling on each of the carriers or very good knowledge about scheduling on each of the carriers. Different embodiments relating to how the network node 200 might identify, select, or determine, the

$${β}_{k}^{res}$$

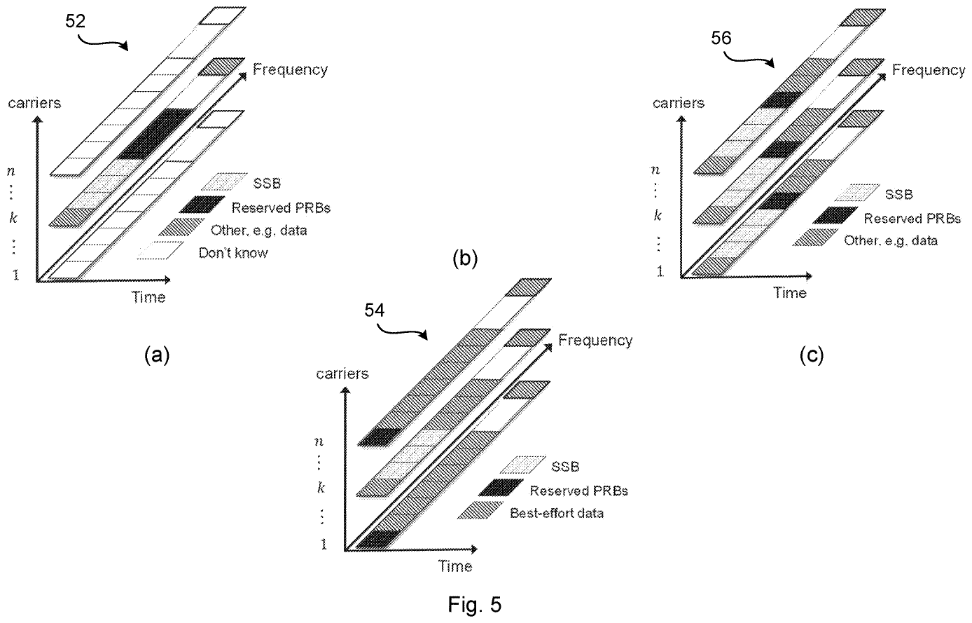

resources to block in such different cases will be disclosed next. Parallel reference is here made to FIG. 5 which illustrates three different examples relating to how much knowledge the network node has about each of the carriers. In FIG. 5(a) is illustrated an example of a time-frequency grid 52 where the scheduler for carrier k has no knowledge about the scheduling on other carriers such that the blocking of resources can only be distributed at the resources allocated to carrier k itself. In FIG. 5(b) and FIG. 5(c) are illustrated examples where network node controlling the scheduler for carrier k has knowledge about the scheduling on other carriers such that the blocking of resources can be distributed among two or more carriers. In FIG. 5(b) is illustrated an example of time-frequency grid 54 where prioritized signals are transmitted on each carrier at the same time. In FIG. 5(c) is illustrated an example of time-frequency grid 56 where a prioritized signal is transmitted on one carrier whilst non-prioritized signals are scheduled for the remaining carriers.

Assume that the network node has very limited knowledge about each of the carriers, and especially that there is not any knowledge when scheduling signals for carrier k regarding what type of signals are scheduled for any of the other carriers. This corresponds to the example illustrated in FIG. 5(a). Then, according to some embodiments, that

$${β}_{k}^{res}$$

resources are to be blocked is determined independently from information about scheduled resources on any other carrier in the symbol in which the prioritized signals are scheduled in

$${β}_{k}^{Prio}$$

resources for carrier k. This corresponds to that the worst case is assumed when scheduling signals for carrier k, i.e., that other carriers will have full resource utilization. Carrier k therefore needs to account for the maximum potential power scaling due to radio power overbooking. This means that, in some embodiments,

$${β}_{k}^{res} \geq \frac{{P}^{0}}{{α}_{k}} \qquad ( 1 )$$

where αₖ represents power spectral density of the prioritized signal for carrier k, to ensure no impact on the PSD of the prioritized signal. A value of

$${β}_{k}^{res}$$

that satisfies this constraint exists if

$${β}_{k}^{max} \geq \frac{{P}^{0}}{{α}_{k}} + {β}_{k}^{SSB} \qquad ( 2 )$$

Alternatively phrased, the maximum allowed power backoff P^{o} configured for radio power overbooking to ensure no impact on the PSD for the prioritized signal is given by

$${P}^{0} \leq {α}_{k} ( ( {β}_{k}^{max} - {β}_{k}^{SSB} ) \qquad ( 3 )$$

This constraint might be taken into consideration by the network node. In particular, in some embodiments, the radio power overbooking is managed by a radio power overbooking setting entity in the network node, and the network node 200 is configured to perform (optional) step S102.

S102: The network node 200 configures the radio power overbooking setting entity to fulfil

$${P}^{0} \leq {α}_{k} ( {β}_{k}^{max} - {β}_{k}^{Prio} ) , with {α}_{k} , {β}_{k}^{Prio} , and {β}_{k}^{max}$$

defined as above.

That is, the radio power overbooking setting entity can take into account that the maximum allowed radio power overbooking is given by (3), and the radio unit will consequently not configure radio power overbooking with a value larger than what is given by (3). The parameter

$${P}_{0}^{max}$$

corresponds to this maximum allowed radio power overbooking value. Alternatively, or in parallel, the network node might trigger a warning that quality of the prioritized signal cannot be ensured, given the current setting of the radio power overbooking, that is, if (1) does not hold, e.g., due to that P^{o} is too large. Hence, in some embodiments, when

$${β}_{k}^{res} < {P}^{0} / {α}_{k} ,$$

with αₖ defined as above, the network node 200 is configured to perform (optional) step S110.

S110: The network node 200 triggers a warning signal that quality of the prioritized signals cannot be ensured.

From the equations (1)-(3) follows that the configured power and the bandwidth of carrier k impact the maximum possible factor to be used by the radio unit when performing radio power overbooking. Needless to say, the total carrier bandwidth must be larger than the bandwidth used for the prioritized signals in each symbol.

In other aspects, it is assumed that the network node has good knowledge of scheduling of all carriers, and especially that all the carriers can block certain resources whenever a prioritized signal is scheduled for transmission on carrier k. This corresponds to the examples in FIG. 5(b) and FIG. 5(c). Hence, in some embodiments, that

$${β}_{k}^{res}$$

resources are to be blocked is determined jointly with determining resources to be scheduled on any other carrier in the symbol in which the prioritized signals are scheduled in

$${β}_{k}^{Prio}$$

resources for carrier k. The network node needs to inform the scheduler of each carrier when (in time) the additional scheduler rule of blocking

$${β}_{k}^{res}$$

does apply. Typically, the schedulers for all carriers need to apply the blocking rule whenever a prioritized signal is scheduled on any carrier. This means that the schedulers of all carriers need to know when (in time) any of the (other) carriers will schedule a prioritized signal. This information could be conveyed to all schedulers semi-statically on carrier setup or via carrier reconfiguration.

When the network node has good knowledge of scheduling of all carriers, an optimal value of

$${β}_{k}^{r e s}$$

can be jointly decided, hence making a much more efficient decision on the blocked resources for each carrier compared to the above aspect. In some embodiments, how many resources to be blocked is determined by solving an optimization problem pertaining to minimizing total number of blocked resources in the symbol, given that the number of blocked resources at least corresponds to the maximum power backoff P^{o} due to radio power overbooking and given constraints on

$${β}_{k}^{P r i o}$$

and on number of total available resources for each carrier. In particular, in some embodiments, the optimization problem is formulated as selecting

$${β}_{k}^{r e s}$$

such that:

$${min}_{{β}_{k}^{res}} {\sum }_{k = 1}^{K} {β}_{k}^{r e s} s . t . \{ \begin{matrix}{\sum }_{k = 1}^{K} {α}_{k} {β}_{k}^{rek} \geq {P}^{o} \\ 0 \leq {β}_{k}^{res} \leq {β}_{k}^{max} - {β}_{k}^{SSB} , ∀ k\end{matrix} \qquad ( 4 )$$

where K represents total number of carriers, and where αₖ represents the PSD of the prioritized signal for carrier k. This optimization problem can be solved using a linear programming method. The solution can be calculated on-line or be tabulated for relevant configurations. The existence of one or more solutions relies on that the radio power overbooking maximum power backoff is not too large in relation to system settings, such as carrier bandwidths.

As expressed in equation (4), finding an optimal allocation of resources to be blocked over the carriers could, for example, be phrased as minimizing the total number of blocked resources, given that the number of blocked resources must at least correspond to the maximum power backoff due to radio power overbooking, and given constraints on the number of available resources for each carrier.

One solution to the optimization problem can be found by spreading the power backoff equally over all carriers. Hence, in some embodiments, equally many resources are blocked for each carrier. This corresponds to that one of the constraints in equation (4) changes to:

$${\sum }_{k = 1}^{K} {α}_{k} {β}_{k}^{r e s} \geq {P}^{o} ⇒ {α}_{k} {β}_{k}^{r e s} \geq {P}^{o} / K , ∀ k$$

which means that the joint optimization in equation (4) can be performed independently per carrier. That is:

$${α}_{k} {β}_{k}^{r e s} \geq {P}^{o} / K , 0 \leq {β}_{k}^{r e s} \leq {β}_{k}^{max} - {β}_{k}^{SSB} , ∀ k$$

The solution can be expressed as:

$${β}_{k}^{r e s} \geq \frac{{P}^{o}}{K {α}_{k}} \qquad ( 5 )$$

In this case the maximum allowed power backoff P^{o} configured for radio power overbooking to ensure no impact on the PSD for the prioritized signal is given by:

$${P}^{o} \leq K {α}_{k} ( {β}_{k}^{max} - {β}_{k}^{S S B} ) \qquad ( 6 )$$

Equation (6) then needs to hold for all k. As can be noted, equations (5) and (6) are thus equal to equations (1) and (3) except for the factor K.

In some examples, scaling of

$${β}_{k}^{r e s}$$

is included in the objective function to, for example, prioritize resources on one or more lower frequency carriers. Hence, in some embodiments, which of the resources to be blocked is a function of frequency, prioritizing blocking of resources at as high frequencies as possible.

That is, a resource on a lower frequency carrier might be worth more than a resource on a high frequency carrier. This can be achieved by associating different weights wₖ with the blocked resources on carrier k. In this, the objective function changes to:

$${min}_{{β}_{k}^{res}} {\sum }_{k = 1}^{K} {w}_{k} {β}_{k}^{r e s}$$

where wₖ are user-parameters used to weights the different carriers. In some examples:

$${\sum }_{k} {w}_{k} = 1 .$$

Blocked resources need to be used in symbols where prioritized signals are scheduled on any carrier. A special, but rather common configuration, would be that all carriers are transmitting prioritized signals in a synchronized fashion, i.e., at the same time.

In some examples, the value of

$${β}_{k}^{r e s}$$

is fixed irrespectively of the symbol time. However, in other examples, the value of

$${β}_{k}^{r e s}$$

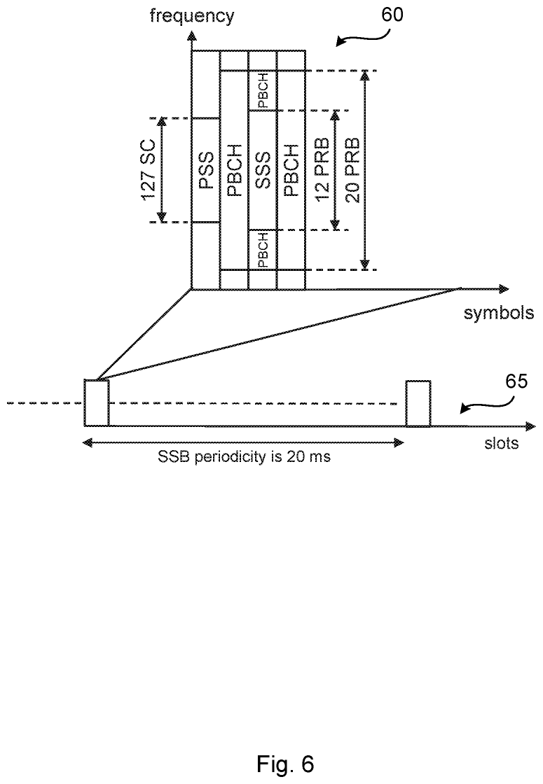

(and associated quantities) could depend on the symbol time (or rather its content). In this respect, in FIG. 6 is schematically illustrated an SSB 60 according to an example. The SSB is composed of a Primary Synchronization Signal (PSS), a Secondary Synchronization Signal (SSS) and a Physical Broadcast Channel (PBCH) spread over four OFDM symbols in time. As illustrated at the timeline 65, one SSB is transmitted in four consecutive OFDM symbols every 20 ms. The blocked resources

$${β}_{k}^{r e s}$$

for all symbols transmitting SSB could be fixed and based on 20 physical resource blocks (PRBs), which corresponds to 7.2 MHz. However, the value of

$${β}_{k}^{res}$$

could alternatively be based on 127 subcarriers (i.e., 3.81 MHz) in the first of the four consecutive symbols of the SSB, and 7.2 MHz in the remaining three symbols of the SSB. If only PSS and SSS need to be protected, then

$${β}_{k}^{res}$$

could be based on 127 sub-carriers (i.e., 3.81 MHz) in the first SSB symbol,

$${β}_{k}^{res}$$

could be based on 12 PRBs=4.32 MHz in the third SSB symbol, and

$${β}_{k}^{res}$$

could be zero for the second and fourth SSB symbols.

In some examples, the frequency resource utilization for the prioritized signal might depend on the numerology used in the network. Taking SSB as an example, for a 30 kHz numerology, the PSS/SSS occupies 3.8 MHz and PBCH occupies 7.2 MHz. Similarly, the time resource utilization depends on a number of network settings. A typical mid-band SSB configuration could require 7.2 MHz in four consecutive symbols every 20 ms, as in the example of FIG. 6

Different assumptions impact the optimization problem expressed in equation (4) and, thus, its solution. For example, consider the case that the network node has the knowledge that whenever carrier m transmits a prioritized signal, then all other carriers send best-effort data. Then

$${β}_{k}^{SSB} = 0 , k \neq m ,$$

meaning that the constraint in equation (4) essentially becomes

$$0 \leq {β}_{k}^{res} \leq {β}_{k}^{max}$$

for all carriers k≠m carrying best-effort data.

In some alternatives, the maximum potential power scaling is handled by a subset of all carriers, implying that the optimization in equation (4) is performed over a subset of the carriers. Hence, in some embodiments, the optimization problem is solved for a subset of the carriers.

In some aspects, static power boosting of the prioritized signals (based on fixed PSD αₖ per carrier) can be considered. Hence, in some embodiments, the network node 200 is configured to perform (optional) step S104.

S104: The network node 200 boosts transmission power allocated to the

$${β}_{k}^{Prio}$$

resources in which the prioritized signals are scheduled for carrier k before determining that the

$${β}_{k}^{res}$$

resources are to be blocked.

This can, for example, be achieved by increasing the resource utilization for the prioritized signals. For example, if a prioritized signal by default requires

$${β}_{k}^{SSB} = 7.2 MHz ,$$

then 3 dB power boosting of the prioritized signal would mean that

$${β}_{k}^{SSB} = 2 \cdot 7.2 = 14.4 MHz .$$

In some aspects, only a part of the maximum radio power overbooking power backoff P^{o} is considered. In particular, in some embodiments,

$${β}_{k}^{res}$$

is a function of γ·P^{o}, where 0<γ<1 is a scale factor. That is, resources can be constrained according to only a fraction of the maximum radio power overbooking power backoff γ·P^{o}. One reason for this could, for example, be that the prioritized signal is deemed resilience enough to handle some degree of radio power scaling, or that the radio power overbooking functionality only partly scales the power. In the latter case, it could, for example, be so that the radio power overbooking functionality partly scales the power and partly relaxes Error Vector Magnitude (EVM) power backoffs (relaxed power clipping) that does not significantly affect some signals that use a low modulation and coding scheme.

It is foreseen that some carriers might be deactivated (and hence, unused). In this case the maximum power backoff P^{o} to consider can be reduced by a factor corresponding to the number of deactivated carriers. Hence, in some embodiments, the scale factor γ is defined by how many of the K carriers that are deactivated. Deactivation of carriers might be handled (semi-) dynamically and hence the scheduler rules of blocked resources (representing the values of

$${β}_{k}^{res} )$$

) should be (semi-) dynamically updated. It is, however, still feasible even with independent schedulers for each carrier, as carrier deactivation typically is managed by RRM. Hence, whenever a carrier is activated or deactivated, new values of

$${β}_{k}^{res}$$

need to be calculated and sent to the schedulers.

As noted above, there could be different examples of the prioritized signals. In some non-limiting examples, the prioritized signals are any of: SSB signals, Tracking Reference Signals (TRSs), Channel State Information Reference Signals (CSI-RSs), data and/or control signals for prioritized user services, such as emergency user services or time-critical data. Further in this respect, there could be more scheduler rules targeting, for example, symbols where TRS or CSI-RS are transmitted, with corresponding values for

$${β}_{k}^{res} .$$

Hence, there could be parameters such as

$${β}_{k}^{SSB , res} , {β}_{k}^{TRS , res} , {β}_{k}^{CSI - RS , res} ,$$

etc. For example, if scheduling SSB, then

$${β}_{k}^{SSB , res}$$

resources need to be blocked, if scheduling TRS, then

$${β}_{k}^{TRS , res}$$

resources need to be blocked, and if scheduling both SSB and TRS, then

$${β}_{k}^{SSB , res} + {β}_{k}^{TRS , res}$$

resources need to be blocked. Further, the optimization problem in equation (4) might be extended with additional constraints with different priorities for different types of prioritized signals. Hence, in some embodiments, there are at least two different types of prioritized signals, with different priorities, scheduled in the

$${β}_{k}^{Prio}$$

resources for carrier k. For example, resources for SSB could have highest priority, resources for time-critical information could have medium priority, and resources for best-effort data could have lowest priority. One approach could be to let the network node calculate and provide the schedulers with several sets of blocked resources, where different sets are conditioned on type of scheduled prioritized signals. For example, one set can be used whenever best-effort data is scheduled, and other sets are used when time-critical data is scheduled, where the choice of set could depend on the maximum resource utilization of time-critical data.

Two illustrative examples will be disclosed next. The first example represents a worst-case, where each carrier individually has to handle the maximum potential radio power overbooking backoff. The second example represents an optimal-case, where a joint decision over all carriers can be taken at setup time, i.e., where all carriers jointly can handle the maximum power backoff (even though the schedulers for the carriers might operate fully independently). By proper parameter tuning, additional in-between cases, e.g. handling a fraction of max power backoff, considering a subset of carriers, weighting different carriers, etc., can be addressed.

As a first illustrative example, consider a radio unit with a maximum power of 60 W for transmission of two carriers (carrier 1 and carrier 2), each configured with an output power 40 W and a bandwidth of 20 MHz. Assume further that a prioritized signal is to be transmitted on any, or both, of the two carriers. In this example,

$$\begin{matrix}{α}_{k} = \\ 2 W / MHz , {β}_{k}^{SSB} = 7.2 MHz\end{matrix}$$

and radio power overbooking with P^{o}=60−40=20 W is used. As

$${α}_{k} ( {β}_{k}^{max} - {β}_{k}^{SSB} ) = 2 ( 20 - 7.2 ) = 25.6 W ,$$

and since 25.6>20, the constraint in equation (3) is satisfied and the worst-case solution according to equation (1) yields

$${β}_{k}^{res} = 20 / 2 = 10 MHz .$$

Hence, if the worst-case solution needs to be applied, the network node will inform the schedulers associated with carrier 1 and carrier 2 to block (i.e., not use) 10 MHz of resources in the symbols where a prioritized signal is scheduled. If, on the other hand, knowledge of scheduling on other carriers is available, there are several optimal solutions that are more resource effective than the worst-case solution. Solving equation (4) yields, for example, the solutions

$$\begin{matrix}\{ {β}_{1}^{res} = \\ 10 , {β}_{2}^{res} = 0 \} , \{ {β}_{1}^{res} = 0 , {β}_{2}^{res} = 10 \} , \{ {β}_{1}^{res} = 5 , {β}_{2}^{res} = 5 \} ,\end{matrix}$$

where the last solution coincides with equation (5). Compared to the worst-case solution, these solutions are 50% more resource effective if prioritized signals are sent on both carriers at the same time.

As a second illustrative example, consider a radio unit with a maximum power of 60 W for transmission of three carriers (carrier 1, carrier 2, and carrier 3), each configured with an output power of 40 W, 20 W, and 20 W, respectively, and a bandwidth of 20 MHz, 10 MHz, and 10 MHz, respectively. Assume further that a prioritized signal is to be transmitted on at least one of the three carriers. Also in this example, αₖ=2 W/MHz,

$${β}_{k}^{SSB} = 7.2$$

MHz and radio power overbooking with P^{o}=20 W is used. However, as αₖ

$$( {β}_{k}^{max} - {β}_{k}^{SSB} ) = 2 ( 10 - 7.2 ) = 5.6 < 20 ,$$

the constraint in equation (3) is not satisfied and there exists no worst-case solution. If a worst-case solution is still desirable, the network node needs to inform the radio power overbooking setup function that a maximum P^{o}=5.6 W power backoff can be used. If, on the other hand, knowledge of scheduling on other carriers is available, there are several solutions to equation (4) that can be found. Some solutions are:

$$\begin{matrix}\{ {β}_{1}^{res} = \\ 7.2 , {β}_{2}^{res} = 0 , {β}_{3}^{res} = 2.8 \} .\end{matrix}$$

In this example it is noted that carrier 2 and carrier 3 have too little bandwidth in relation to the bandwidth of the prioritized signal for equation (6) to hold, and hence equation (5) is not a solution.

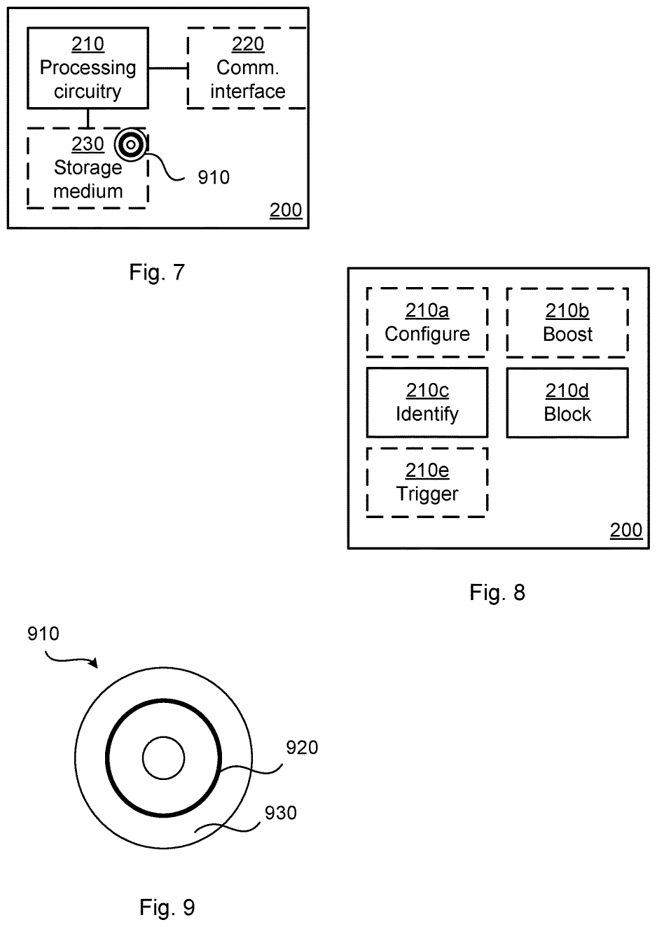

FIG. 7 schematically illustrates, in terms of a number of functional units, the components of a network node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 910 (as in FIG. 9), e.g. in the form of a storage medium 230. The processing circuitry 210 may further be provided as at least one application specific integrated circuit (ASIC), or field programmable gate array (FPGA).

Particularly, the processing circuitry 210 is configured to cause the network node 200 to perform a set of operations, or steps, as disclosed above. For example, the storage medium 230 may store the set of operations, and the processing circuitry 210 may be configured to retrieve the set of operations from the storage medium 230 to cause the network node 200 to perform the set of operations. The set of operations may be provided as a set of executable instructions.

Thus the processing circuitry 210 is thereby arranged to execute methods as herein disclosed. The storage medium 230 may also comprise persistent storage, which, for example, can be any single one or combination of magnetic memory, optical memory, solid state memory or even remotely mounted memory. The network node 200 may further comprise a communications interface 220 at least configured for communications with other entities, functions, nodes, and devices. As such the communications interface 220 may comprise one or more transmitters and receivers, comprising analogue and digital components. The processing circuitry 210 controls the general operation of the network node 200 e.g. by sending data and control signals to the communications interface 220 and the storage medium 230, by receiving data and reports from the communications interface 220, and by retrieving data and instructions from the storage medium 230. Other components, as well as the related functionality, of the network node 200 are omitted in order not to obscure the concepts presented herein.

FIG. 8 schematically illustrates, in terms of a number of functional modules, the components of a network node 200 according to an embodiment. The network node 200 of FIG. 8 comprises a number of functional modules; an identify module 210c configured to perform step S106, and a block module 210d configured to perform step S108. The network node 200 of FIG. 8 may further comprise a number of optional functional modules, such as any of a configure module 210a configured to perform step S102, a boost module 210b configured to perform step S104, and a trigger module 210e configured to perform step S110. In general terms, each functional module 210a:210e may in one embodiment be implemented only in hardware and in another embodiment with the help of software, i.e., the latter embodiment having computer program instructions stored on the storage medium 230 which when run on the processing circuitry makes the network node 200 perform the corresponding steps mentioned above in conjunction with FIG. 8. It should also be mentioned that even though the modules correspond to parts of a computer program, they do not need to be separate modules therein, but the way in which they are implemented in software is dependent on the programming language used. Preferably, one or more or all functional modules 210a:210e may be implemented by the processing circuitry 210, possibly in cooperation with the communications interface 220 and/or the storage medium 230. The processing circuitry 210 may thus be configured to from the storage medium 230 fetch instructions as provided by a functional module 210a:210e and to execute these instructions, thereby performing any steps as disclosed herein.

The network node 200 may be provided as a standalone device or as a part of at least one further device. For example, the network node 200 may be provided in a node of the radio access network or in a node of the core network. Alternatively, functionality of the network node 200 may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time. Thus, a first portion of the instructions performed by the network node 200 may be executed in a first device, and a second portion of the of the instructions performed by the network node 200 may be executed in a second device; the herein disclosed embodiments are not limited to any particular number of devices on which the instructions performed by the network node 200 may be executed. Hence, the methods according to the herein disclosed embodiments are suitable to be performed by a network node 200 residing in a cloud computational environment. Therefore, although a single processing circuitry 210 is illustrated in FIG. 7 the processing circuitry 210 may be distributed among a plurality of devices, or nodes. The same applies to the functional modules 210a:210e of FIG. 8 and the computer program 920 of FIG. 9.

FIG. 9 shows one example of a computer program product 910 comprising computer readable storage medium 930. On this computer readable storage medium 930, a computer program 920 can be stored, which computer program 920 can cause the processing circuitry 210 and thereto operatively coupled entities and devices, such as the communications interface 220 and the storage medium 230, to execute methods according to embodiments described herein. The computer program 920 and/or computer program product 910 may thus provide means for performing any steps as herein disclosed. In the example of FIG. 9, the computer program product 910 is illustrated as an optical disc, such as a CD (compact disc) or a DVD (digital versatile disc) or a Blu-Ray disc. The computer program product 910 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 920 is here schematically shown as a track on the depicted optical disk, the computer program 920 can be stored in any way which is suitable for the computer program product 910.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for scheduling prioritized signals for transmission on carriers using a radio unit with radio power overbooking, wherein the radio unit has a maximum power capability P^{max} and the radio unit and the carriers are configured with a total power P>P^{max}, wherein the method is performed by a network node, and wherein the method comprises:
identifying a maximum power backoff P^{o} due to the radio power overbooking as P^{o}=P−P^{max}; and
blocking
$${β}_{k}^{res}$$
resources not carrying the prioritized signals from being scheduled for carrier k in a symbol where the prioritized signals are scheduled, where the prioritized signals are scheduled in
$${β}_{k}^{Prio}$$
resources for carrier k, and where
$${β}_{k}^{res}$$
is a function of
$${β}_{k}^{Prio}$$
and P^{o}.

2. The method according to claim 1, wherein there are K carriers in total, wherein each of the carriers has its own scheduler, and wherein the scheduler for carrier k is operable independently of any other of the schedulers.

3. The method according to claim 1, wherein that
$${β}_{k}^{res}$$
resources are to be blocked is determined by a baseband entity or a scheduler setup entity in the network node, and wherein information that the
$${β}_{k}^{res}$$
resources are to be blocked is provided to a scheduler in the network node for carrier k.

4. The method according to claim 3, wherein information that
$${β}_{k}^{res}$$
resources are to be blocked is provided as an index to a table accessible to the scheduler for carrier k.

5. The method according to claim 1, wherein that
$${β}_{k}^{res}$$
resources are to be blocked is determined independently from information about scheduled resources on any other carrier in the symbol in which the prioritized signals are scheduled
$${β}_{k}^{Prio}$$
resources for carrier k.

6. The method according to claim 1, wherein
$${β}_{k}^{res}$$
is determined as:
$${β}_{k}^{res} \geq \frac{{P}^{o}}{{α}_{k}} ,$$
where αₖ represents power spectral density of the prioritized signal for carrier k.

7. The method according to claim 1, wherein the radio power overbooking is managed by a radio power overbooking setting entity in the network node, and wherein the method further comprises:
configuring the radio power overbooking setting entity to fulfil
$${P}^{o} \leq {α}_{k} ( {β}_{k}^{max} - {β}_{k}^{Prio} ) ,$$
where αₖ represents power spectral density of the prioritized signal for carrier k, and where
$${β}_{k}^{max}$$
represents total number of resources for carrier k.

8. The method according to claim 1, wherein, when
$${β}_{k}^{res} < {P}^{o} / {α}_{k} , where {β}_{k}^{max} \geq {P}^{o} / {α}_{k} + {β}_{k}^{Prio} ,$$
where αₖ represents power spectral density of the prioritized signal for carrier k, the method further comprises:
triggering a warning signal that quality of the prioritized signals cannot be ensured.

9. The method according to claim 1, wherein that
$${β}_{k}^{res}$$
resources are to be blocked is determined jointly with determining resources to be scheduled on any other carrier in the symbol in which the prioritized signals are scheduled in
$${β}_{k}^{Prio}$$
resources for carrier k.

10-14. (canceled)

15. The method according to claim 1, wherein the method further comprises:
boosting transmission power allocated to the
$${β}_{k}^{Prio}$$
resources in which the prioritized signals are scheduled for carrier k before determining that the
$${β}_{k}^{res}$$
resources are to be blocked.

16-18. (canceled)

19. The method according to claim 1, wherein the prioritized signals are any of: Synchronization Signal Block, SSB, signals, Tracking Reference Signals, TRSs, Channel State Information Reference Signals, CSI-RSs, data and/or control signals for prioritized user services.

20. The method according to claim 1, wherein there are at least two different types of prioritized signals, with different priorities, scheduled in the
$${β}_{k}^{Prio}$$
resources for carrier k.

21. The method according to claim 1, wherein the resources to be blocked are defined in terms of a frequency interval or number of physical resource blocks, PRBs.

22. A network node for scheduling prioritized signals for transmission on carriers using a radio unit with radio power overbooking, wherein the radio unit has a maximum power capability P^{max} and the radio unit and the carriers are configured with a total power P>P^{max}, wherein the network node comprises processing circuitry, and wherein the processing circuitry is configured to cause the network node to:
identify a maximum power backoff P^{o} due to the radio power overbooking as P^{o}=P−P^{max}; and
block
$${β}_{k}^{r e s}$$
resources not carrying the prioritized signals from being scheduled for carrier k in a symbol where the prioritized signals are scheduled, where the prioritized signals are scheduled in
$${β}_{k}^{P r i o}$$
resources for carrier k, and where
$${β}_{k}^{r e s}$$
is a function of
$${β}_{k}^{P r i o}$$
and P^{o}.

23. (canceled)

24. The network node according to claim 22, further being configured to perform a method for scheduling prioritized signals for transmission on carriers using a radio unit with radio power overbooking, wherein the radio unit has a maximum power capability P^{max} and the radio unit and the carriers are configured with a total power P>P^{max}, wherein the method is performed by a network node, and wherein the method comprises:
Identifying a maximum power backoff P^{o} due to the radio power overbooking as P^{o}=P−P^{max}; and
blocking
$${β}_{k}^{r e s}$$
resources not carrying the prioritized signals from being scheduled for carrier k in a symbol where the prioritized signals are scheduled, where the prioritized signals are scheduled in
$${β}_{k}^{P r i o}$$
resources for carrier k, and where
$${β}_{k}^{r e s}$$
is a function of
$${β}_{k}^{P r i o}$$
and P^{o},
wherein there are K carriers in total, wherein each of the carriers has its own scheduler, and wherein the scheduler for carrier k is operable independently of any other of the schedulers.

25. A computer program for scheduling prioritized signals for transmission on carriers using a radio unit with radio power overbooking, wherein the radio unit has a maximum power capability P^{max} and the radio unit and the carriers are configured with a total power P>P^{max}, wherein the computer program comprises computer code which, when run on processing circuitry of a network node, causes the network node to:
identify a maximum power backoff P^{o} due to the radio power overbooking as P^{o}=P−P^{max}; and
block
$${β}_{k}^{r e s}$$
resources not carrying the prioritized signals from being scheduled for carrier k in a symbol where the prioritized signals are scheduled, where the prioritized signals are scheduled in
$${β}_{k}^{P r i o}$$
resources for carrier k, and where
$${β}_{k}^{r e s}$$
is a function of
$${β}_{k}^{P r i o}$$
and P^{o}.

26. A computer program product comprising a computer program according to claim 25, and a computer readable storage medium on which the computer program is stored.
